(19) United States
(12) Patent Application Publication
(10) Pub. No.: US 2025/0223241 A1
(43) Pub. Date: Jul. 10, 2025

(54) Ph-Buffering Synergistic Carrier For Reducing Ammonia Volatilization In Urea, And Preparation Method And Use Thereof

(71) Applicant: INST OF AGRI RESOURCES AND REGIONAL PLANNING, CAAS, Beijing (CN)

(72) Inventors: Liang YUAN, Beijing (CN); Yange YAN, Beijing (CN); Bingqiang ZHAO, Beijing (CN); Jiukai XU, Beijing (CN); Meng XU, Beijing (CN); Shuiqin ZHANG, Beijing (CN); Yanting LI, Beijing (CN); Wei WANG, Beijing (CN)

(21) Appl. No.: 19/010,139

(22) Filed: Jan. 5, 2025

Related U.S. Application Data
(63) Continuation of application No. PCT/CN2024/071558, filed on Jan. 10, 2024.

(51) Int. Cl. C05G 3/00; C05C 9/00; C05G 5/23

(52) U.S. Cl. CPC C05G 3/00; C05C 9/005; C05G 5/23

(57) ABSTRACT

The present disclosure belongs to the technical field of efficient utilization of fertilizers, and specifically relates to a pH-buffering synergistic carrier for reducing ammonia volatilization in urea, and a preparation method and use thereof. In the present disclosure, a hydroxyl-containing organic acid and alkali are used as raw materials to obtain a pH buffer. A pH buffer performance protectant prepared from chelating precipitant as a main raw material is combined with the pH buffer to prepare the pH-buffering synergistic carrier. The pH buffer protection agent prevents the pH buffer from reacting with metal ions in the soil. The pH-buffering synergistic carrier is combined with urea, and an R—CO—NH—CO—NH2 structure formed by R—COOH in the carrier and an amino group of the urea can effectively enhance a stability of the pH value in a urea fertilizer micro-domain, thus ensuring the supply of a nitrogen fertilizer while reducing ammonia volatilization losses.

### CROSS REFERENCE TO RELATED APPLICATION

This patent application is a national stage application of International Patent Application No. PCT/CN2024/071558, filed on Jan. 10, 2024.

### TECHNICAL FIELD

The present disclosure belongs to the technical field of efficient utilization of fertilizers, and specifically relates to a pH-buffering synergistic carrier for reducing ammonia volatilization in urea, and a preparation method and use thereof.

### BACKGROUND

Urea is an important type of nitrogen fertilizer in the world, accounting for 50% of the global nitrogen fertilizers. Ammonia volatilization is an important loss pathway for urea nitrogen fertilizer, and the ammonia volatilization caused by nitrogen fertilizer application on farmland accounts for about 40% of agricultural emission sources. Therefore, the development of novel high-efficiency urea products that can reduce the ammonia volatilization in urea is of great significance to improve nitrogen utilization efficiency, protect the environment, and cope with global climate change.

At present, people mainly reduce the ammonia volatilization loss in urea by developing products such as coated urea and stable urea. A principle of the coated urea to reduce ammonia volatilization includes: coating a surface of the urea with semi-permeable or impermeable membrane materials such as resin and polyurethane to slowly release nutrients; after the urea is converted into ammonium bicarbonate, there is a lower concentration of ammonium ions in a fertilizer micro-domain. At this time, an ammonia partial pressure is lower, thereby reducing the ammonia volatilization loss. A principle of the stable urea to reduce ammonia volatilization is to add urease inhibitors such as N-(n-butyl) thiophosphoric triamide (NBPT) into urea particles or during urea application to slow down the conversion of urea into ammonium bicarbonate, thereby reducing the ammonia volatilization loss.

A main way for the coated urea and stable urea to reduce the ammonia volatilization loss in urea is to control the release of urea and regulate the conversion of urea, thereby reducing the ammonium concentration in the urea fertilizer micro-domain. However, when being used in farmland, the coated urea and stable urea generally have the problem of mismatch between the release and transformation of nutrients and the crop demands. That is to say, when crops require a large amount of nutrients during the critical growth period, fertilizers are generally unable to be released or converted in insufficient amounts, resulting in insufficient nutrient supply or even reduced crop yields. Accordingly, it is an important way to coordinate high crop yields and environmental protection by maintaining a high ammonium concentration in the urea fertilization micro-domain and ensuring nutrient supply while reducing the ammonia volatilization losses.

### SUMMARY

An objective of the present disclosure is to provide a pH-buffering synergistic carrier for reducing ammonia volatilization in urea, and a preparation method and use thereof. In the present disclosure, the pH-buffering synergistic carrier can reduce the ammonia volatilization loss in urea while maintaining a high ammonium concentration in the urea fertilization micro-domain.

To achieve the above objective, the present disclosure provides the following technical solutions:

The present disclosure provides a buffering synergistic carrier, including a pH buffer and a buffer performance protectant; where
the pH buffer includes a hydroxyl-containing organic acid, a first alkaline compound, and water; there are not less than 3 types of the hydroxyl-containing organic acid; and the pH buffer has a pH value of 5 to 7; and
the buffer performance protectant includes a chelating precipitant, a second alkaline compound, and water; and the buffer performance protectant has a pH value of 5 to 7.

Preferably, the hydroxyl-containing organic acid is three or more selected from the group consisting of citric acid, lactic acid, malic acid, gluconic acid, tartaric acid, salicylic acid, lactobionic acid, and glycolic acid.

Preferably, the hydroxyl-containing organic acid includes the following components in parts by weight:
200 parts to 400 parts of the citric acid;
100 parts to 200 parts of the lactic acid;
50 parts to 100 parts of the malic acid;
100 parts to 200 parts of the gluconic acid;
30 parts to 80 parts of the tartaric acid; and
20 parts to 50 parts of the salicylic acid.

Preferably, the first alkaline compound is one or more selected from the group consisting of potassium hydroxide, sodium hydroxide, potassium carbonate, potassium bicarbonate, sodium carbonate, and sodium bicarbonate.

Preferably, the water in the pH buffer has a chloride ion content of less than or equal to 200 mg/L; and the water in the buffer performance protectant has a chloride ion content of less than or equal to 200 mg/L.

Preferably, the chelating precipitant includes a chelating agent and a precipitant.

Preferably, the chelating agent is an aminopolycarboxylic acid chelating agent.

Preferably, the aminopolycarboxylic acid chelating agent is one or two selected from the group consisting of ethylenediaminetetraacetic acid (EDTA) and diethylenetriaminepentaacetic acid (DTPA).

Preferably, the precipitant is one or more selected from the group consisting of oxalic acid, succinic acid, glutaric acid, and adipic acid.

Preferably, the second alkaline compound is one or more selected from the group consisting of potassium hydroxide, sodium hydroxide, potassium carbonate, potassium bicarbonate, sodium carbonate, and sodium bicarbonate.

Preferably, the chelating precipitant includes the following components in parts by weight:
130 parts to 260 parts of the chelating agent; and
400 parts to 650 parts of the precipitant.

Preferably, the precipitant includes the following components in parts by weight:
200 parts to 300 parts of the oxalic acid;
100 parts to 150 parts of the succinic acid;
50 parts to 100 parts of the glutaric acid; and
50 parts to 100 parts of the adipic acid; and
the chelating agent includes the following components in parts by weight:
100 parts to 200 parts of the EDTA; and
30 parts to 60 parts of the DTPA.

Preferably, the pH buffer and the buffer performance protectant are at a volume ratio of 1:(0.5-2).

The present disclosure further provides a preparation method of the buffering synergistic carrier, including the following steps:
(1) premixing the hydroxyl-containing organic acid and then mixing with the first alkaline compound and the water to obtain the pH buffer;
(2) premixing the chelating agent and the precipitant and then mixing with the second alkaline compound and the water to obtain the buffer performance protectant; and
(3) mixing the pH buffer with the buffer performance protectant to obtain the buffering synergistic carrier; where
steps (1) and (2) are conducted in any order.

Preferably, the hydroxyl-containing organic acid and the water in step (1) are at a mass ratio of (200-600):1000.

Preferably, a total mass of the chelating agent and the precipitant and a mass of the water in step (2) are at a ratio of (100-300):1000.

The present disclosure further provides use of the buffering synergistic carrier or a buffering synergistic carrier prepared by the preparation method in fertilization or buffering synergistic urea granules.

Preferably, the use of the buffering synergistic carrier in the fertilization includes the following steps:
mixing the buffering synergistic carrier with urea to obtain a mixed fertilizer, and then applying the mixed fertilizer.

Preferably, the buffering synergistic carrier and the urea are at a volume-to-mass ratio of (2-20) L:1000 kg.

Preferably, the use of the buffering synergistic carrier in the buffering synergistic urea granules specifically includes a first method and a second method;

the first method is adopted when the buffering synergistic carrier and the urea are at a volume-to-mass ratio of (2-6) L:1000 kg, and includes the following steps:
based on a process of producing granular urea by fluidized bed granulation, adding the buffering synergistic carrier into a urea melt after a second evaporation section, and granulating an obtained urea modified liquid to obtain the buffering synergistic urea granules; and
the second method is adopted when the buffering synergistic carrier and the urea are at a volume-to-mass ratio of (7-20) L:1000 kg, and includes the following steps:
based on a process of producing the granular urea by high-tower granulation, adding the buffering synergistic carrier into the urea melt between a first evaporation section and the second evaporation section, and granulating the obtained urea modified liquid to obtain the buffering synergistic urea granules.

The present disclosure provides a buffering synergistic carrier. In the present disclosure, an organic acid and an alkali are used as raw materials. The hydroxyl-containing organic acid is used as a pH buffer, and the chelating precipitant is used as a buffer performance protectant. By reacting, precipitating, and chelating with calcium, iron, aluminum and other metal ions in the soil solution using the chelating precipitant, “two-way protection” of a buffer performance of the pH buffer is achieved. In this way, the pH buffer is prevented from reacting with metal ions in the soil and becomes ineffective, thereby better exerting the buffer performance and reducing the ammonia volatilization loss in urea. The buffering synergistic carrier reduces the ammonia volatilization loss in urea by enhancing a stability of the pH value in a urea fertilizer micro-domain. At the same time, the buffering synergistic carrier is combined with urea, and an R—CO—NH—CO—NH₂ structure formed by the reaction between R—COOH in the buffering synergistic carrier and —NH₂ of the urea can slow down the conversion of urea into ammonium. This process coordinates a contradiction between the supply of urea nitrogen fertilizer and the ammonia volatilization loss, providing a new technological approach for the development of high-efficiency urea products.

The present disclosure further provides a preparation method of the buffering synergistic carrier. In the present disclosure, the preparation method has simple steps, convenient operation, low cost, and wide source of raw materials.

The present disclosure further provides use of the buffering synergistic carrier or a buffering synergistic carrier prepared by the preparation method in fertilization or buffering synergistic urea granules. In the present disclosure, the buffering synergistic carrier can form a pH-buffering area in the urea fertilizer micro-domain during fertilization, especially urea fertilization, thereby effectively reducing the ammonia volatilization loss when there is a high ammonium ion concentration in the soil solution.

In the present disclosure, the buffering synergistic carrier can also be used to produce buffering synergistic urea granules. During the urea production, the buffering synergistic carrier is added into the urea melt to produce a high-efficiency urea product with buffering and loss-reducing functions. This production process requires no secondary processing and does not affect the capacity of a urea production unit.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIGS. 1A-1B show schematic flow chart of the buffering synergistic carrier provided in the present disclosure for preparing the buffering synergistic urea granules; where FIG. 1A is a schematic flow chart of the preparation method when the buffering synergistic carrier and the urea are at a volume-to-mass ratio of (2-6) L:1000 kg; and FIG. 1B is a schematic flow chart of the preparation method when the buffering synergistic carrier and the urea are at a volume-to-mass ratio of (7-20) L:1000 kg;

FIG. 2 shows an action mechanism of the buffering synergistic carrier provided in the present disclosure;

FIG. 3 shows a schematic diagram of the test illustrating an influence of the buffering synergistic carrier provided in the present disclosure on ammonia volatilization;

FIG. 4 shows an experimental schematic diagram of soil ammonia volatilization; and

FIGS. 5A-5B show structural characteristics of the products obtained by reacting the buffering synergistic carrier (taking the hydroxyl-containing organic acid being citric acid as an example) with urea in Use Examples 1 to 6; where FIG. 5A are the liquid chromatograms of ordinary urea and citric acid value-added urea, FIG. 5B are the mass spectrometry of ordinary urea and a citric acid-urea reaction production, U represents the ordinary urea, CAU10 represents is the citric acid value-added urea.

### DETAILED DESCRIPTION OF THE EMBODIMENTS

The present disclosure provides a buffering synergistic carrier, including a pH buffer and a buffer performance protectant; where
the pH buffer includes a hydroxyl-containing organic acid, a first alkaline compound, and water; there are not less than 3 types of the hydroxyl-containing organic acid; and the pH buffer has a pH value of 5 to 7; and
the buffer performance protectant includes a chelating precipitant, a second alkaline compound, and water; the buffer performance protectant has a pH value of 5 to 7; and the chelating precipitant includes a chelating agent and a precipitant.

In the present disclosure, the mass ratio of the hydroxyl-containing organic acid to the first alkaline compound is preferably based on the pH buffer having a pH value of 5 to 7. The pH buffer has a pH value of 5 to 7, and the ammonia volatilization loss can be better controlled within this pH value range.

Preferably, the hydroxyl-containing organic acid is preferably three or more selected from the group consisting of citric acid, lactic acid, malic acid, gluconic acid, tartaric acid, salicylic acid, glycolic acid, lactobionic acid, and glycolic acid, more preferably three or more selected from the group consisting of the citric acid, lactic acid, malic acid, gluconic acid, tartaric acid, and salicylic acid, and even more preferably the citric acid, lactic acid, malic acid, gluconic acid, tartaric acid, and salicylic acid. The hydroxyl-containing organic acid used is safe and environmental-friendly, and has no side effects on the environment.

In the present disclosure, when the hydroxyl-containing organic acid is selected from the citric acid, lactic acid, malic acid, gluconic acid, tartaric acid, and salicylic acid, the hydroxyl-containing organic acid preferably includes 200 parts to 400 parts, more preferably 250 parts to 350 parts, and even more preferably 280 parts to 320 parts of the citric acid; or preferably 100 parts to 200 parts, more preferably 120 parts to 180 parts, and even more preferably 140 parts to 160 parts of the lactic acid; or preferably 50 parts to 100 parts, more preferably 60 parts to 90 parts, and even more preferably 70 parts to 80 parts of the malic acid; or preferably 100 parts to 200 parts, more preferably 120 parts to 190 parts, and even more preferably 150 parts to 170 parts of the gluconic acid; or preferably 30 parts to 80 parts, more preferably 40 parts to 70 parts, and even more preferably 50 parts to 60 parts of the tartaric acid; or preferably 20 parts to 50 parts, more preferably 30 parts to 40 parts, and even more preferably 35 parts of the salicylic acid.

In the present disclosure, the first alkaline compound is preferably one or more selected from the group consisting of potassium hydroxide, sodium hydroxide, potassium carbonate, potassium bicarbonate, sodium carbonate, and sodium bicarbonate.

In the present disclosure, the water in the pH buffer is preferably deionized water; and the water has a chloride ion content of preferably less than or equal to 200 mg/L, more preferably less than or equal to 150 mg/L. The water with low chloride ion content can ensure that the buffering synergistic carrier has a low chloride ion concentration, such that equipment such as urine evaporators are not corroded when the carrier is added during the urea production.

In the present disclosure, the mass ratio of the chelating precipitant and the second alkaline compound is preferably based on the buffer performance protectant having a pH value of 5 to 7. The pH value of the buffering synergistic carrier is adjusted to 5 to 7. First, ammonia volatilization loss can be better controlled within this pH value range. The second is that when controlling the pH value within the above range, the buffering synergistic carrier does not corrode urea production equipment such as metering pumps and urine evaporators during the urea production.

In the present disclosure, the chelating precipitant preferably includes a chelating agent and a precipitant; the chelating agent is preferably an aminopolycarboxylic acid chelating agent; the aminopolycarboxylic acid chelating agent is preferably one or two selected from the group consisting of EDTA and DTPA, and more preferably includes the EDTA and DTPA; and the precipitant is preferably one or more selected from the group consisting of oxalic acid, succinic acid, glutaric acid, and adipic acid, and more preferably includes the oxalic acid, succinic acid, glutaric acid, and adipic acid.

In the present disclosure, the chelating precipitant includes preferably 130 parts to 260 parts, more preferably 150 parts to 240 parts, and even more preferably 180 parts to 210 parts of the chelating agent, as well as preferably 400 parts to 650 parts, more preferably 440 parts to 600 parts, and even more preferably 480 parts to 550 parts of the precipitant.

In the present disclosure, the precipitant includes preferably 200 parts to 300 parts, more preferably 220 parts to 280 parts, and even more preferably 240 parts to 260 parts of the oxalic acid, preferably 100 parts to 150 parts, more preferably 110 parts to 140 parts, and even more preferably 120 parts to 130 parts of the succinic acid, preferably 50 parts to 100 parts, more preferably 60 parts to 90 parts, and even more preferably 70 parts to 80 parts of the glutaric acid, as well as preferably 50 parts to 100 parts, more preferably 60 parts to 90 parts, and even more preferably 75 parts to 85 parts of the adipic acid.

In the present disclosure, the chelating agent includes preferably 100 parts to 200 parts, more preferably 130 parts to 180 parts, and even more preferably 150 parts to 170 parts of the EDTA, as well as preferably 30 parts to 60 parts, more preferably 40 parts to 50 parts, and even more preferably 45 parts of the DTPA.

In the present disclosure, the second alkaline compound is preferably one or more selected from the group consisting of potassium hydroxide, sodium hydroxide, potassium carbonate, potassium bicarbonate, sodium carbonate, and sodium bicarbonate.

In the present disclosure, the water in the buffer performance protectant is preferably deionized water; and the water has a chloride ion content of preferably less than or equal to 200 mg/L, more preferably less than or equal to 150 mg/L. The water with low chloride ion content can ensure that the buffering synergistic carrier has a low chloride ion concentration, such that equipment such as urine evaporators are not corroded when the carrier is added during the urea production.

In the present disclosure, the buffer performance protectant is used. The precipitant precipitates with the metal ions, and the chelating agent forms a stable chelate with the metal ions. The dual protection of “precipitation-chelation” prevents the precipitation between hydroxyl-containing organic acid and metal ions such as Ca²⁺, Mg²⁺, Fe³⁺, and Al³⁺ in the soil, thereby avoiding reducing the buffering effect of the pH buffer and reducing the effect of ammonia volatilization.

In the present disclosure, the pH buffer and the buffer performance protectant are at a volume ratio of preferably 1:(0.5-2), more preferably 1:(1-1.5), and even more preferably 1:1.2.

The present disclosure further provides a preparation method of the buffering synergistic carrier, including the following steps:
(1) premixing the hydroxyl-containing organic acid and then mixing with the first alkaline compound and the water to obtain the pH buffer;
(2) premixing the chelating agent and the precipitant and then mixing with the second alkaline compound and the water to obtain the buffer performance protectant; and
(3) mixing the pH buffer with the buffer performance protectant to obtain the buffering synergistic carrier.

In the present disclosure, the hydroxyl-containing organic acid is premixed and then mixed with the first alkaline compound and the water to obtain the pH buffer. The water in step (1) is preferably deionized water.

In the present disclosure, the hydroxyl-containing organic acid and the water in step (1) are at a mass ratio of preferably (200-600):1000, more preferably (300-500):1000, and even more preferably (350-400):1000.

In the present disclosure, the chelating agent and the precipitant are premixed and then mixed with the second alkaline compound and the water to obtain the buffer performance protectant. A total mass of the chelating agent and the precipitant and a mass of the water are at a ratio of preferably (100-300):1000, more preferably (150-250):1000, further preferably (180-220):1000.

In the present disclosure, the pH buffer is mixed with the buffer performance protectant to obtain the buffering synergistic carrier. The mixing manner is preferably conducted by stirring.

The present disclosure further provides use of the buffering synergistic carrier or a buffering synergistic carrier prepared by the preparation method in fertilization or buffering synergistic urea granules.

In the present disclosure, the use of the buffering synergistic carrier in the fertilization includes preferably the following steps: mixing the buffering synergistic carrier with urea to obtain a mixed fertilizer, and then applying the mixed fertilizer.

In the present disclosure, the volume-to-mass ratio of the buffering synergistic carrier and the urea is preferably determined based on the soil pH value of a urea application area; and the concentration and pH value of the buffering synergistic carrier are preferably determined based on the soil pH value of the urea application area.

In the present disclosure, the buffering synergistic carrier and the urea are at a volume-to-mass ratio of preferably (2-20) L:1000 kg, more preferably (5-15) L:1000 kg, further preferably (8-12) L:1000 kg.

In the present disclosure, the use of the buffering synergistic carrier in the buffering synergistic urea granules preferably includes a first method and a second method;

the first method is adopted when the buffering synergistic carrier and the urea are at a volume-to-mass ratio of (2-6) L:1000 kg, and includes preferably the following steps:
based on a process of producing granular urea by fluidized bed granulation, adding the buffering synergistic carrier into a urea melt after a second evaporation section (excluding the second evaporation section), and granulating an obtained urea modified liquid to obtain the buffering synergistic urea granules; and
the second method is adopted when the buffering synergistic carrier and the urea are at a volume-to-mass ratio of (7-20) L:1000 kg, and includes preferably the following steps:
based on a process of producing the granular urea by high-tower granulation, adding the buffering synergistic carrier into the urea melt between a first evaporation section and the second evaporation section, and granulating the obtained urea modified liquid to obtain the buffering synergistic urea granules.

In the present disclosure, the granulating in the first method is conducted with a particle size of preferably 2 mm to 4 mm, more preferably 2 mm to 3.5 mm, and even more preferably 2 mm to 3 mm.

In the present disclosure, the granulating in the second method is conducted with a particle size of preferably 0.9 mm to 2.5 mm, more preferably 1 mm to 2 mm, and even more preferably 1.5 mm to 2 mm.

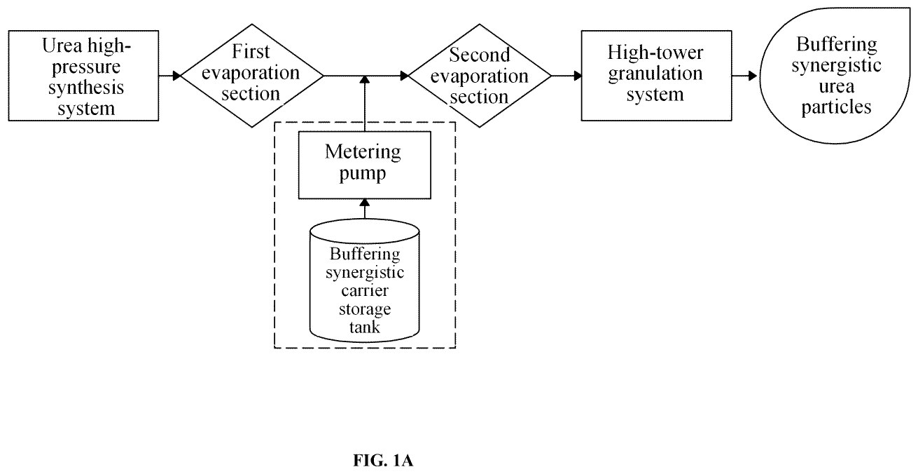

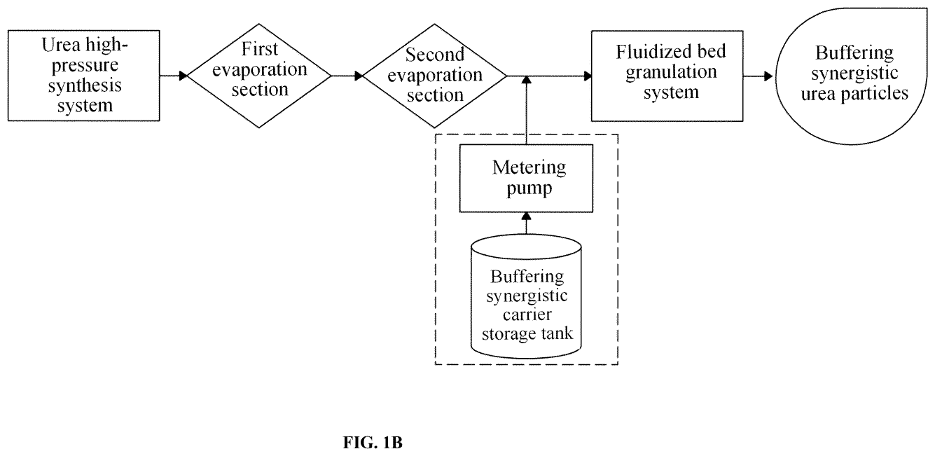

FIGS. 1A-1B show schematic flow chart of the buffering synergistic carrier provided in the present disclosure for preparing the buffering synergistic urea granules; when the buffering synergistic carrier and the urea are at a volume-to-mass ratio of (2-6) L:1000 kg, the buffering synergistic carrier is added into the urea melt after the second evaporation section in urea production; when the buffering synergistic carrier and the urea are at a volume-to-mass ratio of (7-20) L:1000 kg, the buffering synergistic carrier is added into the urea melt between the first evaporation section and the second evaporation section in urea production. The present disclosure takes into consideration the application effect (during the fertilization) and the feasibility of urea production (in the fertilizer) without increasing a load of the urea evaporation and controlling a moisture content of the urea.

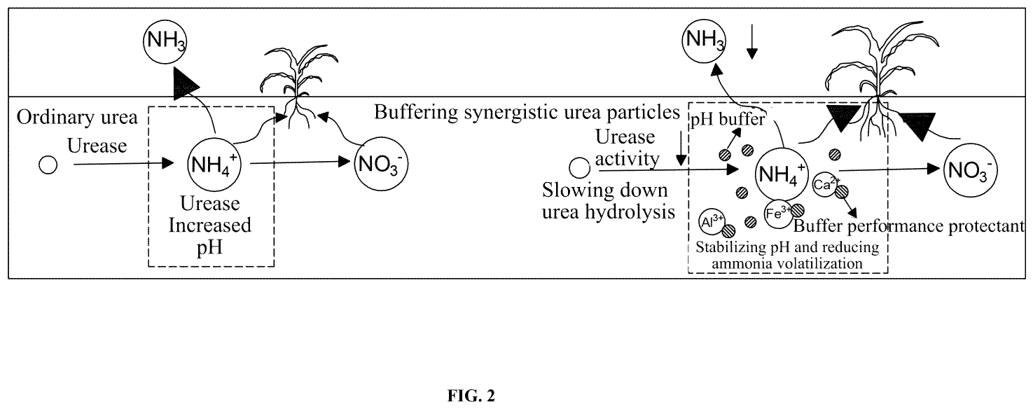

FIG. 2 shows an action mechanism of the buffering synergistic carrier provided in the present disclosure. In the present disclosure, the buffering synergistic carrier and the urea are mixed or directly prepared to obtain the buffering synergistic urea granules, and then applied to the soil. Under the action of urease, urea is ammoniumized into ammonium ions. The buffer performance protectant precipitates or chelates with metal ions in the soil to improve a stability of the buffer performance of the pH buffer, thereby reducing the ammonia volatilization loss in urea while maintaining a high ammonium concentration in the urea fertilizer micro-domain.

In order to further illustrate the present disclosure, the technical solutions provided by the present disclosure are described in detail below in connection with accompanying drawings and examples, but these examples should not be understood as limiting the claimed scope of the present disclosure.

### Example 1

### (1) Preparation of a pH Buffer

(A) citric acid, lactic acid, malic acid, gluconic acid, tartaric acid, and salicylic acid were mixed well according to a mass ratio of 300:150:80:150:50:40 to obtain a hydroxyl-containing mixed acid; and
(B) the hydroxyl-containing mixed acid and deionized water were mixed well at a mass ratio of 400:1000, potassium carbonate was slowly added into a resulting acid solution to adjust a pH value of the acid solution to 6.0 to obtain the pH buffer;

### (2) Preparation of a Buffer Performance Protectant

(A) oxalic acid, succinic acid, glutaric acid, adipic acid, EDTA, and DTPA were mixed well according to a mass ratio of 250:120:80:60:150:50 to obtain a mixed acid; and
(B) the mixed acid and deionized water were mixed well according to a mass ratio of 200:1000, potassium bicarbonate was slowly added into a resulting acid solution to adjust a pH value of the acid solution to 6.0 to obtain the buffer performance protectant;

### (3) Preparation of a Buffering Synergistic Carrier

the pH buffer and the buffer performance protectant were mixed well according to a volume ratio of 1:1 to obtain the buffering synergistic carrier.

### Example 2

### (1) Preparation of a pH Buffer

(A) citric acid, lactic acid, malic acid, gluconic acid, tartaric acid, and salicylic acid were mixed well according to a mass ratio of 200:100:50:100:30:20 to obtain a hydroxyl-containing mixed acid; and
(B) the hydroxyl-containing mixed acid and deionized water were mixed well at a mass ratio of 200:1000, potassium hydroxide was slowly added into a resulting acid solution to adjust a pH value of the acid solution to 5.0 to obtain the pH buffer;

### (2) Preparation of a Buffer Performance Protectant

(A) oxalic acid, succinic acid, glutaric acid, adipic acid, EDTA, and DTPA were mixed well according to a mass ratio of 200:100:50:50:100:30 to obtain a mixed acid; and
(B) the mixed acid and deionized water were mixed well according to a mass ratio of 100:1000, sodium hydroxide was slowly added into a resulting acid solution to adjust a pH value of the acid solution to 5.0 to obtain the buffer performance protectant;

### (3) Preparation of a Buffering Synergistic Carrier

the pH buffer and the buffer performance protectant were mixed well according to a volume ratio of 1:0.5 to obtain the buffering synergistic carrier.

### Example 3

### (1) Preparation of a pH Buffer

(A) citric acid, lactic acid, malic acid, gluconic acid, tartaric acid, and salicylic acid were mixed well according to a mass ratio of 400:200:100:200:80:50 to obtain a hydroxyl-containing mixed acid; and
(B) the hydroxyl-containing mixed acid and deionized water were mixed well at a mass ratio of 600:1000, sodium carbonate was slowly added into a resulting acid solution to adjust a pH value of the acid solution to 7.0 to obtain the pH buffer;

### (2) Preparation of a Buffer Performance Protectant

(A) oxalic acid, succinic acid, glutaric acid, adipic acid, EDTA, and DTPA were mixed well according to a mass ratio 300:150:100:100:200:60 to obtain a mixed acid; and
(B) the mixed acid and deionized water were mixed well according to a mass ratio of 300:1000, sodium bicarbonate was slowly added into a resulting acid solution to adjust a pH value of the acid solution to 7.0 to obtain the buffer performance protectant;

### (3) Preparation of a Buffering Synergistic Carrier

the pH buffer and the buffer performance protectant were mixed well according to a volume ratio of 1:2 to obtain the buffering synergistic carrier.

### Example 4

### (1) Preparation of a pH Buffer

(A) citric acid, lactic acid, malic acid, gluconic acid, tartaric acid, and salicylic acid were mixed well according to a mass ratio of 350:180:90:190:70:40 to obtain a hydroxyl-containing mixed acid; and
(B) the hydroxyl-containing mixed acid and deionized water were mixed well at a mass ratio of 500:1000, sodium carbonate was slowly added into a resulting acid solution to adjust a pH value of the acid solution to 6.0 to obtain the pH buffer;

### (2) Preparation of a Buffer Performance Protectant

(A) oxalic acid, succinic acid, glutaric acid, adipic acid, EDTA, and DTPA were mixed well according to a mass ratio 280:140:90:90:180:50 to obtain a mixed acid; and
(B) the mixed acid and deionized water were mixed well according to a mass ratio of 250:1000, sodium bicarbonate was slowly added into a resulting acid solution to adjust a pH value of the acid solution to 6.0 to obtain the buffer performance protectant;

### (3) Preparation of a Buffering Synergistic Carrier

the pH buffer and the buffer performance protectant were mixed well according to a volume ratio of 1:1.5 to obtain the buffering synergistic carrier.

### Example 5

### (1) Preparation of a pH Buffer

(A) citric acid, lactic acid, malic acid, gluconic acid, tartaric acid, and salicylic acid were mixed well according to a mass ratio of 320:160:80:170:60:35 to obtain a hydroxyl-containing mixed acid; and
(B) the hydroxyl-containing mixed acid and deionized water were mixed well at a mass ratio of 400:1000, sodium carbonate was slowly added into a resulting acid solution to adjust a pH value of the acid solution to 6.0 to obtain the pH buffer;

### (2) Preparation of a Buffer Performance Protectant

(A) oxalic acid, succinic acid, glutaric acid, adipic acid, EDTA, and DTPA were mixed well according to a mass ratio 260:130:80:85:170:45 to obtain a mixed acid; and
(B) the mixed acid and deionized water were mixed well according to a mass ratio of 220:1000, sodium bicarbonate was slowly added into a resulting acid solution to adjust a pH value of the acid solution to 6.0 to obtain the buffer performance protectant;

### (3) Preparation of a Buffering Synergistic Carrier

the pH buffer and the buffer performance protectant were mixed well according to a volume ratio of 1:1.2 to obtain the buffering synergistic carrier.

### Example 6

### (1) Preparation of a pH Buffer

(A) citric acid, lactic acid, malic acid, gluconic acid, tartaric acid, and salicylic acid were mixed well according to a mass ratio of 200:100:50:100:30:20 to obtain a hydroxyl-containing mixed acid; and
(B) the hydroxyl-containing mixed acid and deionized water were mixed well at a mass ratio of 200:1000, sodium carbonate was slowly added into a resulting acid solution to adjust a pH value of the acid solution to 6.0 to obtain the pH buffer;

### (2) Preparation of a Buffer Performance Protectant

(A) oxalic acid, succinic acid, glutaric acid, adipic acid, EDTA, and DTPA were mixed well according to a mass ratio of 200:100:50:50:100:30 to obtain a mixed acid; and
(B) the mixed acid and deionized water were mixed well according to a mass ratio of 100:1000, sodium bicarbonate was slowly added into a resulting acid solution to adjust a pH value of the acid solution to 6.0 to obtain the buffer performance protectant;

### (3) Preparation of a Buffering Synergistic Carrier

the pH buffer and the buffer performance protectant were mixed well according to a volume ratio of 1:0.5 to obtain the buffering synergistic carrier.

### Use Example 1

During the application of urea, the buffering synergistic carrier and the urea were mixed at a volume-to-mass ratio of 50:1000 and then applied.

### Use Example 2

During the application of urea, the buffering synergistic carrier and the urea were mixed at a volume-to-mass ratio of 2:1000 and then applied.

### Use Example 3

During the conventional urea production (FIGS. 1A-1B), the buffering synergistic carrier added to urea was 2 L/t. After the second evaporation section, the buffering synergistic carrier was added to a urea melt obtained in this section.

### Use Example 4

During the conventional urea production (FIGS. 1A-1B), the buffering synergistic carrier added to urea was 6 L/t. After the second evaporation section, the buffering synergistic carrier was added to a urea melt obtained in this section.

### Use Example 5

During the conventional urea production (FIGS. 1A-1B), the buffering synergistic carrier added to urea was 7 L/t. Between the first evaporation section and the second evaporation section, the buffering synergistic carrier was added to a urea melt obtained in this section.

### Use Example 6

During the conventional urea production (FIGS. 1A-1B), the buffering synergistic carrier added to urea was 20 L/t. Between the first evaporation section and the second evaporation section, the buffering synergistic carrier was added to a urea melt obtained in this section.

### Test Example 1

### Studying an Effect of the Buffering Synergistic Carrier in Reducing Ammonia Volatilization in Ammonium Bicarbonate Solution

(1) Ammonium bicarbonate was formed after urea was hydrolyzed. In this test, the ammonium bicarbonate was used to simulate a relatively high ammonia concentration in the urea fertilizer micro-domain.

The buffering synergistic carriers prepared in Examples 4 to 6 with low concentration (21 g/L), medium concentration (38 g/L), and high concentration (55 g/L) were selected, with a pH value of 6. The 3 buffer synergistic carriers were separately mixed with distilled water at a volume ratio of 20:1000 to obtain test buffers, which were recorded as L, M, and H, respectively.

The ammonium bicarbonate and the test buffers were separately evenly mixed according to a fertilizer-to-water ratio of 1:500 to obtain the corresponding ammonium bicarbonate solutions; meanwhile, an ammonium bicarbonate solution of the same concentration was prepared using distilled water as a control (the ammonium bicarbonate solution and distilled water were at a volume ratio of 1:500), recorded as CK.

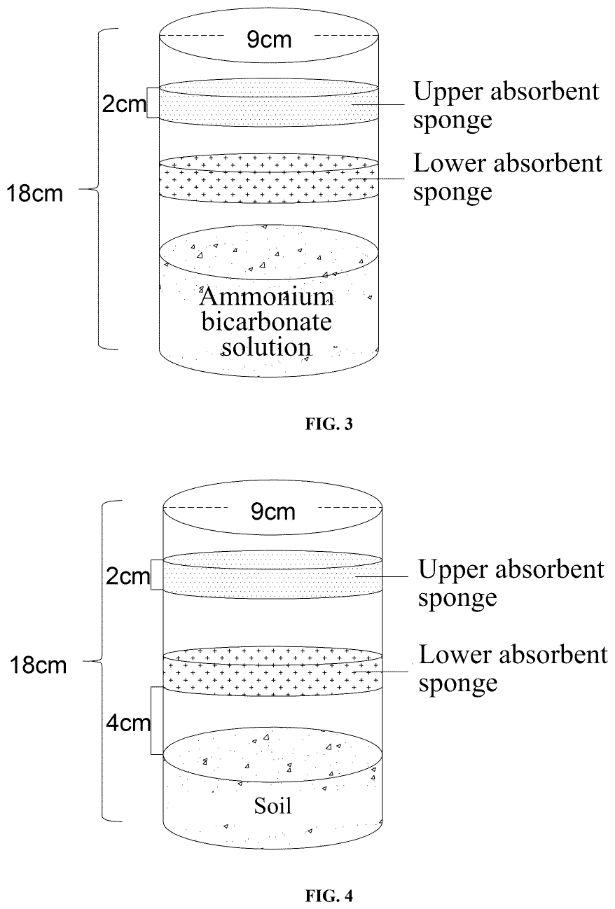

100 mL of the ammonium bicarbonate solution was placed in a 1 L culture bottle and cultured in a 25° C. climate chamber, and an influence of the buffering synergistic carrier on ammonia volatilization was explored using an “aeration method” to collect NH₃ (referring to FIG. 3 for instrument installation). Sampling was conducted after 1 d of culture. The ammonium nitrogen absorbed in the sponge was extracted with 1 mol·L⁻¹ KCl solution and measured with a continuous flow injection analyzer (SEAL, AA3) to calculate the volatilization of NH₃. Each treatment was repeated 3 times, and the results were shown in Table 1.

TABLE 1
Effect of buffering synergistic carrier on reducing ammonia
volatilization in ammonium bicarbonate solution

| | Ammonia volatilization | Ammonia volatilization reduction |
|---|---|---|
| Group | (N mg/L) | rate compared with that in CK |
| CK | 1454.5 | / |
| L | 947.6 | 34.8% |
| M | 862.0 | 40.7% |
| H | 759.4 | 47.8% |

As shown in Table 1, the buffering synergistic carrier provided by the present disclosure could significantly reduce the ammonia volatilization loss in the ammonium bicarbonate solution, with an average reduction of 41.1%; where the group H could reduce the ammonia volatilization loss by 47.8%.

### Test Example 2

### Influence of the Buffering Synergistic Carrier on Urea Conversion

Preparation of fertilizers: the buffering synergistic carriers prepared in Examples 4 to 6 with low concentration (21 g/L), medium concentration (38 g/L), and high concentration (55 g/L) at a pH value of 6 were separately added into a urea melt (130° C.) according to a volume-to-mass ratio of 1:100. The obtained products were separately cooled, crushed, and passed through a 0.149 mm sieve to obtain urea samples LU, MU, and HU, respectively, while ordinary urea (U) was used as a control.

The determination of urea conversion rate was based on GB/T 35113-2017. 0.500 g of test urea samples (U, NU, NEU, and NCU) were separately added into 100 mL of a urease solution (activity: 1 U/mg, concentration: 0.15 g/L), and cultured in a (37±2° C.) incubator for 1 h. After measuring using p-dimethylaminobenzaldehyde colorimetric method, the conversion rate of urea was calculated using the following formula. The results were shown in Table 2.

Urea conversion rate (%)=(initial urea nitrogen content−remaining urea nitrogen content after conversion)/initial urea nitrogen content×100

TABLE 2
Influence of buffering synergistic carrier on urea conversion

| Group | Urea conversion rate (%) |
|---|---|
| U | 22.71 |
| LU | 16.93 |
| MU | 16.77 |
| HU | 14.08 |

As shown in Table 2, compared with the ordinary urea U, the LU, MU, and HU could all slow down the conversion of urea, with urea conversion rates significantly reduced by 5.78%, 5.95%, and 8.63%, respectively.

### Test Example 3

### Influence of the Buffering Synergistic Carrier on the Ammonia Volatilization in Urea

The experiment was designed according to the principle of equal nitrogen amount. A nitrogen application rate was 0.3 g/kg of dry soil. 4 treatments were set up: ordinary urea U, low concentration buffering synergistic carrier LU, medium concentration buffering synergistic carrier MU, and high concentration buffering synergistic carrier HU.

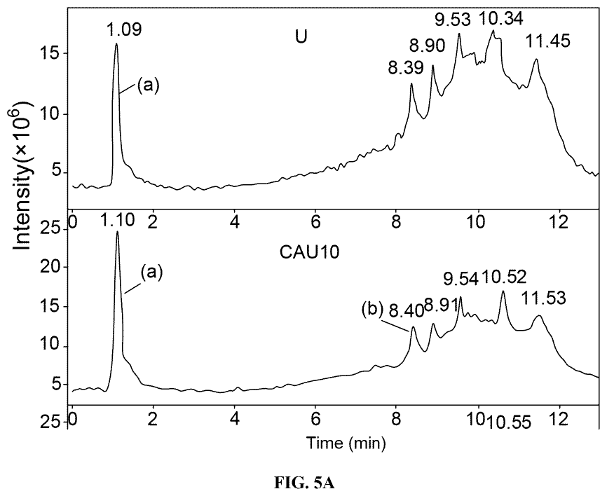

An air-dried soil sample equivalent to 100 g of dry soil (passed through a 2 mm sieve) was placed in a culture bottle with a volume of 1,000 mL with a small hole drilled on its lid. The soil moisture content was adjusted to 50% of the maximum water holding capacity in the field, and the soil was pre-cultured for 3 d in a constant-temperature incubator at 25° C. in the dark to activate the activity of soil microorganisms. After the pre-culture, the weighed test fertilizer was added into the soil according to the experimental design, mixed thoroughly and adjusted to a soil moisture content of 20%. NH₃ was collected using the “aeration method” (referring to FIG. 4 for instrument installation) and cultured in a 25° C. climate chamber in the dark. Sampling was conducted on the 1st, 2nd, and 3rd days after cultivation. The ammonium nitrogen absorbed in the sponge was extracted with 1 mol·L⁻¹ KCl solution and measured with a flow analyzer to calculate NH₃ volatilization in the soil, and each treatment was repeated 3 times. Meanwhile, the soil pH value was measured.

The data were analyzed using SPSS23 software and Duncan's new multiple range method for variance analysis and correlation analysis, and the results were shown in Table 3.

TABLE 3
Effect of buffering synergistic carrier on
reducing ammonia volatilization in urea

| | | | | | Ammonia volatilization |
|---|---|---|---|---|---|
| | Culture days | | | | reduction rate compared |
| Group | 1 d | 2 d | 3 d | Mean (g/m²) | with that in U |
| U | 79.33 | 238.4 | 283.2 | 200.3 | / |
| LU | 77.73 | 210.4 | 251.6 | 179.9 | 10.2% |
| MU | 57.23 | 183.6 | 225.5 | 155.4 | 22.4% |
| HU | 53.01 | 158.9 | 190.7 | 134.2 | 33.0% |

According to Table 3, compared with the ordinary urea U, the LU, MU, and HU could all slow down the ammonia volatilization in urea, with a reduction ratio reaching up to 33%.

### Test Example 4

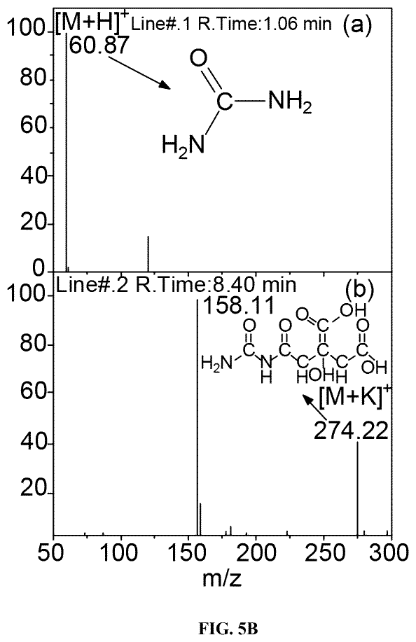

The structures of the products obtained by reacting the buffering synergistic carrier in Use Examples 1 to 6 with urea were characterized, and the results were shown in FIGS. 5A-5B. As shown in FIGS. 5A-5B, after the buffering synergistic carrier was combined with urea, R—COOH in the pH buffer reacted with —NH₂ of the urea to form an R—CO—NH—CO—NH₂ structure.

It can be seen from the above examples that the buffering synergistic carrier provided by the present disclosure can reduce the ammonia volatilization loss in urea and slow down the conversion of urea into ammonium, thereby coordinating the contradiction between the supply of urea nitrogen fertilizer and the ammonia volatilization loss.

Although the present disclosure is described in detail in conjunction with the foregoing examples, they are only a part of, not all of, the examples of the present disclosure. Other examples can be obtained based on these examples without creative efforts, and all of these examples shall fall within the protection scope of the present disclosure.

What is claimed is:

1. A buffering synergistic carrier, comprising a pH buffer and a buffer performance protectant; wherein
the pH buffer comprises a hydroxyl-containing organic acid, a first alkaline compound, and water; there are not less than 3 types of the hydroxyl-containing organic acid; and the pH buffer has a pH value of 5 to 7; and
the buffer performance protectant comprises a chelating precipitant, a second alkaline compound, and water; and the buffer performance protectant has a pH value of 5 to 7.

2. The buffering synergistic carrier according to claim 1, wherein the hydroxyl-containing organic acid is three or more selected from the group consisting of citric acid, lactic acid, malic acid, gluconic acid, tartaric acid, salicylic acid, glycolic acid, lactobionic acid, and glycolic acid.

3. The buffering synergistic carrier according to claim 1, wherein the hydroxyl-containing organic acid comprises the following components in parts by weight:
200 parts to 400 parts of the citric acid;
100 parts to 200 parts of the lactic acid;
50 parts to 100 parts of the malic acid;
100 parts to 200 parts of the gluconic acid;
30 parts to 80 parts of the tartaric acid; and
20 parts to 50 parts of the salicylic acid.

4. The buffering synergistic carrier according to claim 1, wherein the first alkaline compound is one or more selected from the group consisting of potassium hydroxide, sodium hydroxide, potassium carbonate, potassium bicarbonate, sodium carbonate, and sodium bicarbonate.

5. The buffering synergistic carrier according to claim 1, wherein the water in the pH buffer has a chloride ion content of less than or equal to 200 mg/L; and the water in the buffer performance protectant has a chloride ion content of less than or equal to 200 mg/L.

6. The buffering synergistic carrier according to claim 1, wherein the chelating precipitant comprises a chelating agent and a precipitant.

7. The buffering synergistic carrier according to claim 6, wherein the chelating agent is an aminopolycarboxylic acid chelating agent.

8. The buffering synergistic carrier according to claim 7, wherein the aminopolycarboxylic acid chelating agent is one or two selected from the group consisting of ethylenediaminetetraacetic acid (EDTA) and diethylenetriaminepentaacetic acid (DTPA).

9. The buffering synergistic carrier according to claim 6, wherein the precipitant is one or more selected from the group consisting of oxalic acid, succinic acid, glutaric acid, and adipic acid.

10. The buffering synergistic carrier according to claim 1, wherein the second alkaline compound is one or more selected from the group consisting of potassium hydroxide, sodium hydroxide, potassium carbonate, potassium bicarbonate, sodium carbonate, and sodium bicarbonate.

11. The buffering synergistic carrier according to claim 6, wherein the chelating precipitant comprises the following components in parts by weight:
130 parts to 260 parts of the chelating agent; and
400 parts to 650 parts of the precipitant.

12. The buffering synergistic carrier according to claim 6, wherein the precipitant comprises the following components in parts by weight:
200 parts to 300 parts of the oxalic acid;
100 parts to 150 parts of the succinic acid;
50 parts to 100 parts of the glutaric acid; and
50 parts to 100 parts of the adipic acid; and
the chelating agent comprises the following components in parts by weight:
100 parts to 200 parts of the EDTA; and
30 parts to 60 parts of the DTPA.

13. The buffering synergistic carrier according to claim 1, wherein the pH buffer and the buffer performance protectant are at a volume ratio of 1:(0.5-2).

14. A preparation method of the buffering synergistic carrier according to claim 1, comprising the following steps:
(1) premixing the hydroxyl-containing organic acid and then mixing with the first alkaline compound and the water to obtain the pH buffer;
(2) premixing the chelating agent and the precipitant and then mixing with the second alkaline compound and the water to obtain the buffer performance protectant; and
(3) mixing the pH buffer with the buffer performance protectant to obtain the buffering synergistic carrier; wherein
steps (1) and (2) are conducted in any order.

15. The preparation method according to claim 14, wherein the hydroxyl-containing organic acid and the water in step (1) are at a mass ratio of (200-600):1000.

16. The preparation method according to claim 14, wherein a total mass of the chelating agent and the precipitant and a mass of the water in step (2) are at a ratio of (100-300):1.

17. The buffering synergistic carrier according to claim 2, wherein the hydroxyl-containing organic acid comprises the following components in parts by weight:
200 parts to 400 parts of the citric acid;
100 parts to 200 parts of the lactic acid;
50 parts to 100 parts of the malic acid;
100 parts to 200 parts of the gluconic acid;
30 parts to 80 parts of the tartaric acid; and
20 parts to 50 parts of the salicylic acid.

18. The buffering synergistic carrier according to claim 7, wherein the chelating precipitant comprises the following components in parts by weight:
130 parts to 260 parts of the chelating agent; and
400 parts to 650 parts of the precipitant.

19. The buffering synergistic carrier according to claim 8, wherein the chelating precipitant comprises the following components in parts by weight:
130 parts to 260 parts of the chelating agent; and
400 parts to 650 parts of the precipitant.

20. The buffering synergistic carrier according to claim 9, wherein the chelating precipitant comprises the following components in parts by weight:
130 parts to 260 parts of the chelating agent; and
400 parts to 650 parts of the precipitant.
